(19) United States
(12) Patent Application Publication
(10) Pub. No.: US 2026/0093328 A1
(43) Pub. Date: Apr. 2, 2026

(54) patentdocketing@polsinelli.com

(71) Applicant: Razer (Asia-Pacific) Pte. Ltd., Singapore (SG)

(72) Inventors: Kah Yong LEE, Singapore (SG); Whee Min TAN, Singapore (SG)

(73) Assignee: Razer (Asia-Pacific) Pte. Ltd., Singapore (SG)

(21) Appl. No.: 19/113,455

(22) PCT Filed: Oct. 31, 2022
(86) PCT No.: PCT/SG2022/050787

§ 371 Date: Mar. 20, 2025

(51) Int. Cl. G06F 3/01

(52) U.S. Cl. CPC G06F 3/016

(57) ABSTRACT

A method may include receiving a first media stream from a first terminal and a second media stream from a second terminal; decoding the first and second media streams to obtain a first and second contents in a playable format; associating the first media stream and the second media stream with a first identifier and a second identifier; generating a first initial haptic signal based on the first content and the first identifier and a second initial haptic signal based on the second content and the second identifier; processing the first/second content to generate a first/second analysis; modulating the first initial haptic signal according to the first analysis to output a first haptic control signal and the second initial haptic signal according to the second analysis to output a second haptic control signal; and driving an actuator according to the first and/or the second haptic control signal.

### TECHNICAL FIELD

The present disclosure generally relates to a method and a system for generating haptic effects, in particular, from media streams.

### BACKGROUND

Electronic devices provide tactile feedback (such as vibration, texture, and heat) to users, generally known as haptic feedback or haptic effects.

Therefore, there exists a need for a method or system that provides improved haptic effect, thereby augmenting user experience.

### SUMMARY

According to a first aspect of the present disclosure, a method for generating haptic effects is provided. The method may include receiving a first media stream from a first terminal; receiving a second media stream from a second terminal, the second terminal being different from the first terminal; decoding the first media stream to obtain a first content in a playable format, and decoding the second media stream to obtain a second content in the playable format; associating the first media stream and the second media stream with a first identifier and a second identifier, respectively, the first identifier and/or the second identifier being one identifier among a group of predetermined identifiers; generating a first initial haptic signal based on the first content and the associated first identifier, and generating a second initial haptic signal based on the second content and the associated second identifier; processing the first content to generate a first analysis on the first content, and processing the second content to generate a second analysis on the second content; modulating the first initial haptic signal according to the first analysis to output a first haptic control signal, and modulating the second initial haptic signal according to the second analysis to output a second haptic control signal; and driving an actuator according to the first haptic control signal and/or the second haptic control signal.

According to a second aspect of the present disclosure, a system for generating haptic effects is provided. The system may include at least one processor and at least one memory including computer program code for one or more programs, the at least one memory and the computer program code configured to, with the at least one processor, cause the system at least to: receive a first media stream from a first terminal; receive a second media stream from a second terminal, the second terminal being different from the first terminal; decode the first media stream to obtain a first content in a playable format, and decoding the second media stream to obtain a second content in the playable format;
associate the first media stream and the second media streams with a first identifier and a second identifier, respectively, the first identifier and/or the second identifier being one identifier among a group of predetermined identifiers; generate a first initial haptic signal based on the first content and the associated first identifier, and generating a second initial haptic signal based on the second content and the associated second identifier; process the first content to generate a first analysis on the first content, and processing the second content to generate a second analysis on the second content; modulate the first initial haptic signal according to the first analysis to output a first haptic control signal, and modulating the second initial haptic signal according to the second analysis to output a second haptic control signal; and drive an actuator according to the first haptic control signal and/or the second haptic control signal.

According to a third aspect of the present disclosure, a system for generating haptic effects is provided. The system may include a receiver, configured to receive a first media stream from a first terminal and a second media stream from a second terminal, the second terminal being different from the first terminal; a media processing module, configured to decode the first media stream to obtain a first content in a playable format, and decoding the second media stream to obtain a second content in the playable format, and configured to associate the first media stream and the second media streams with a first identifier and a second identifier, respectively, the first identifier and/or the second identifier being one identifier among a group of predetermined identifiers; a haptic module, configured to generate a first initial haptic signal based on the first content and the associated first identifier, and generating a second initial haptic signal based on the second content and the associated second identifier; a machine-learning module, configured to process, by a machine-learning module, the first content to generate a first analysis on the first content, and processing the second content to generate a second analysis on the second content; a haptic driver, configured to modulate the first initial haptic signal according to the first analysis to output a first haptic control signal, and modulating the second initial haptic signal according to the second analysis to output a second haptic control signal; and an actuator, configured to be driven according to the first haptic control signal and/or the second haptic control signal.

According to a fourth aspect of the present disclosure, a method for generating haptic effect is provided. The method may include receiving a plurality of media streams, each of the plurality of media streams from a different one of a plurality of terminals; decoding the plurality of media streams to obtain a plurality of contents in playable formats; associating each of the plurality of media streams with a corresponding identifier, the corresponding identifier selected from a group of predetermined identifiers; generating a plurality of initial haptic signals based on the plurality of contents and the associated corresponding identifiers; processing the plurality of contents to generate a plurality of analysis; modulating the plurality of initial haptic signals according to the plurality of analysis to output a plurality of haptic control signals; and actuating the plurality of haptic control signals.

### BRIEF DESCRIPTION OF THE DRAWINGS

FIG. 1A is a diagram showing an example system according to an embodiment of the present disclosure; FIG. 1B is a diagram showing an example process according to an embodiment of the present disclosure.

FIG. 2 is a flow chart showing an example method according to an embodiment of the present disclosure.

FIG. 3 is a block diagram showing an example system according to an embodiment of the present disclosure.

FIG. 4 is a block diagram showing a media processing module of the example system of FIG. 3.

FIGS. 5A and 5B are block diagrams showing a haptic module of the example system of FIG. 3.

FIGS. 6A and 6B are diagrams showing a machine-learning module of the example system of FIG. 3;

FIG. 7 is a block diagram showing a haptic driver of the example system of FIG. 3.

FIG. 8 is a flow chart showing a process performed in the haptic driver of FIG. 7.

FIGS. 9A and 9B is a diagram showing a respective example system according to an embodiment of the present disclosure.

FIG. 10 is a diagram showing media stream transmission occurred in an example system according to an embodiment of the present disclosure.

FIG. 11 is a block diagram showing an example electronic device 1100, according to an embodiment of the present disclosure.

### DETAILED DESCRIPTION

Embodiments described below in the context of a device, apparatus, or system are analogously valid for the respective methods, and vice versa. Furthermore, it will be understood that the embodiments described below may be combined, for example, a part of one embodiment may be combined with a part of another embodiment, and a part of one embodiment may be combined with a part of another embodiment.

It should be understood that the terms “on”, “over”, “top”, “bottom”, “down”, “side”, “back”, “left”, “right”, “front”, “back”, “lateral”, “side”, “up”, “down”, “vertical”, “horizontal” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or”is intended to include “and”unless the context clearly indicates otherwise.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Approximating language, as used herein throughout the specification and claims, may be applied to modify any quantitative representation that could permissibly vary without resulting in a change in the basic function to which it is related. Accordingly, a value modified by a term or terms, such as “about,” “substantially”, is not limited to the precise value specified but within tolerances that are acceptable for operation of the embodiment for an application for which it is intended. In some instances, the approximating language may correspond to the precision of an instrument for measuring the value.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various aspects of what is described here seek to provide a system comprising: a receiver, configured to receive a first media stream from a first terminal and a second media stream from a second terminal, the second terminal being different from the first terminal; a media processing module, configured to decode the first media stream to obtain a first content in a playable format, and decoding the second media stream to obtain a second content in the playable format, and configured to associate the first media stream and the second media streams with a first identifier and a second identifier, respectively, the first identifier and/or the second identifier being one identifier among a group of predetermined identifiers; a haptic module, configured to generate a first initial haptic signal based on the first content and the associated first identifier, and generating a second initial haptic signal based on the second content and the associated second identifier; a machine-learning module, configured to process, by a machine-learning module, the first content to generate a first analysis on the first content, and processing the second content to generate a second analysis on the second content; a haptic driver, configured to modulate the first initial haptic signal according to the first analysis to output a first haptic control signal, and modulating the second initial haptic signal according to the second analysis to output a second haptic control signal; and an actuator, configured to be driven according to the first haptic control signal and/or the second haptic control signal. A corresponding method is also provided.

According to various aspects, the proposed system may be configured to concurrently receive the first media stream from the first device and the second media stream from the second device, and process (e.g. decode, manipulate, mix, combine, analyze, etc.) the first and second media streams by a single System-on-Chip (SoC) having all the modules or two SoCs with each SoC having all the modules. The system may be configured to output playable media signal and haptic signal synchronized with the playable media signal.

According to various aspects, the machine-learning module may be configured to generate the first analysis so as to comprise information about whether the first content comprises an undesirable content and generate the second analysis so as to comprise information about whether the second content comprises an undesirable content. The proposed system may utilize a machine-learning module to detect the undesirable content (e. g. voice) that is not desirable to actuate haptic effects. The machine-learning module may be trained by a plurality of known files including, but not limited to, game profiles, voice profiles (e. g. speech) and music profiles such that the machine-learning module may detect undesirable content (e. g. voice). The training profiles may be customizable by a user as a reference of preference. Accordingly, the user may customize haptic events and non-haptic events by loading customized training profiles to the machine-learning module.

In some instances, aspects of the systems and techniques described here provide technical improvements and advantages over existing approaches. For example, the proposed system and method may provide an improved user experience at least for the following reasons. The proposed system and method may concurrently (e. g. simultaneously) process two inputs from different terminals and output combined (a combination of the first and second media streams) or selected (e. g. the first media stream or the second media stream) media and haptic signals. The proposed method may include associating the media stream/content (e. g. audio stream/audio content) with an identifier so as to remove/suppress/reduce undesirable haptic effects for undesirable content (e. g. audio content) if the associated identifier is a predefined identifier (e. g. voice). The proposed method may further include generating, by the machine-learning module, an analysis including a further identifier associated with the content (e.g. audio content) so as to further remove/suppress/reduce undesirable haptic effects for undesirable content (e. g. audio content) if the associated further identifier is the predefined identifier (e. g. voice). Accordingly, through double determination on if the associated (further) identifier is the predefined identifier (e. g. voice), the proposed system may provide more accurate haptic effects by providing more accurate haptic control signals, thereby improving user experience. Particularly, by utilizing a machine-learning module, the algorithm on processing the content (e.g. audio content) to generate an analysis on the content (e. g. audio content) may be customizable, such that the user may determine on whether the content (e. g. audio content) may actuate haptic effects, e. g. by adjusting the threshold on accuracy of training.

The proposed method may be scalable to include: receiving a plurality of media streams, each of the plurality of media streams from a different one of a plurality of terminals; decoding the plurality of media streams to obtain a plurality of contents (e.g. audio contents) in playable formats; associating each of the plurality of media streams with a corresponding identifier, the corresponding identifier selected from a group of predetermined identifiers; generating a plurality of initial haptic signals based on the plurality of contents (e.g. audio contents) and the associated corresponding identifiers; processing the plurality of contents (e.g. audio contents) to generate a plurality of analysis; modulating the plurality of initial haptic signals according to the plurality of analysis to output a plurality of haptic control signals; and driving an actuator according to the plurality of haptic control signals.

The following examples pertain to various aspects of the present disclosure.

Example 1 is a method including: receiving a first media stream from a first terminal; receiving a second media stream from a second terminal, the second terminal being different from the first terminal; decoding the first media stream to obtain a first content in a playable format, and decoding the second media stream to obtain a second content in the playable format; associating the first media stream and the second media stream with a first identifier and a second identifier, respectively, the first identifier and/or the second identifier being one identifier among a group of predetermined identifiers; generating a first initial haptic signal based on the first content and the associated first identifier, and generating a second initial haptic signal based on the second content and the associated second identifier; processing the first content to generate a first analysis on the first content, and processing the second content to generate a second analysis on the second content; modulating the first initial haptic signal according to the first analysis to output a first haptic control signal, and modulating the second initial haptic signal according to the second analysis to output a second haptic control signal; and driving an actuator according to the first haptic control signal and/or the second haptic control signal.

In Example 2, the subject matter of Example 1 may optionally include that processing the first content and the second content is by a machine-learning module configured to generate the first analysis so as to comprise information about whether the first content comprises an undesirable content and generate the second analysis so as to comprise information about whether the second content comprises an undesirable content.

In Example 3, the subject matter of Example 2 may optionally include that the machine-learning module is trained by processing a plurality of audio profiles, the plurality of audio profiles comprising a game profile, a voice profile and/or a music profile.

In Example 4, the subject matter of Example 3 may optionally include that a threshold of accuracy for the training is preset.

In Example 5, the subject matter of Example 1 may optionally include that the step of generating a first initial haptic signal and generating a second initial haptic signal comprises generating the first and second initial haptic signals using an audio-to-haptic algorithm.

In Example 6, the subject matter of Example 5 may optionally include that a first audio-to-haptic algorithm is selected in accordance with the first identifier associated with the first media stream and a second audio-to-haptic algorithm is selected in accordance with the second identifier associated with the second media stream.

In Example 7, the subject matter of Example 1 may optionally include that the group of predetermined identifiers comprises identifiers categorized by frequency.

In Example 7, the subject matter of Example 1 may optionally include that if the first content and/or the second content is associated with a predefined identifier among the group of predetermined identifiers, the step of modulating the first initial haptic signal and modulating the second initial haptic signal comprises modulating the first initial haptic signal associated with the predefined identifier with a haptic-reduced indication and/or modulating the second initial haptic signal associated with the predefined identifier with a haptic-reduced indication.

In Example 9, the subject matter of Example 8 may optionally include that the group of predetermined identifiers comprises voice, media streaming or the like, wherein the predefined identifier is voice.

In Example 10, the subject matter of Example 8 may optionally include that the first analysis comprises a first further identifier and the second analysis comprises a second further identifier, the first further identifier and/or the second further identifier being one identifier among a further group of predetermined identifiers.

In Example 11, the subject matter of Example 10 may optionally include that if the first content and/or the second content is not associated with the predefined identifier and if the first analysis comprises the first further identifier being the predefined identifier and/or the second analysis comprises the second further identifier being the predefined identifier, the step of modulating the first initial haptic signal and modulating the second initial haptic signal comprises modulating the first initial haptic signal to output the first haptic control signal with the haptic-reduced indication and/or modulating the second initial haptic signal to output the second haptic control signal with the haptic-reduced indication.

In Example 12, the subject matter of Example 10 may optionally include that if the first analysis does not comprise the first further identifier being the predefined identifier and/or the second analysis does not comprise the second further identifier being the predefined identifier, the step of modulating the first initial haptic signal and modulating the second initial haptic signal comprises modulating the first initial haptic signal to output the first haptic control signal with a haptic pattern and/or modulating the second initial haptic signal to output the second haptic control signal with a haptic pattern.

In Example 13, the subject matter of Example 1 may optionally include that the first media stream and the second media stream occur concurrently.

In Example 14, the subject matter of Example 13 may optionally include receiving the first media stream from the first terminal at a first time; receiving the second media stream from the second terminal at a second time alternating with the first time.

In Example 15, the subject matter of Example 1 may optionally include, prior to the step of driving an actuator, combining the first and second haptic control signals; and driving the actuator according to the combined haptic signal.

Example 16 is a system including at least one processor and at least one memory including computer program code for one or more programs, the at least one memory and the computer program code configured to, with the at least one processor, cause the system at least to: receive a first media stream from a first terminal; receive a second media stream from a second terminal, the second terminal being different from the first terminal; decode the first media stream to obtain a first content in a playable format, and decoding the second media stream to obtain a second content in the playable format; associate the first media stream and the second media streams with a first identifier and a second identifier, respectively, the first identifier and/or the second identifier being one identifier among a group of predetermined identifiers; generate a first initial haptic signal based on the first content and the associated first identifier, and generating a second initial haptic signal based on the second content and the associated second identifier; process the first content to generate a first analysis on the first content, and processing the second content to generate a second analysis on the second content; modulate the first initial haptic signal according to the first analysis to output a first haptic control signal, and modulating the second initial haptic signal according to the second analysis to output a second haptic control signal; and drive an actuator according to the first haptic control signal and/or the second haptic control signal.

Example 17 is a system including: a receiver, configured to receive a first media stream from a first terminal and a second media stream from a second terminal, the second terminal being different from the first terminal; a media processing module, configured to decode the first media stream to obtain a first content in a playable format, and decoding the second media stream to obtain a second content in the playable format, and configured to associate the first media stream and the second media streams with a first identifier and a second identifier, respectively, the first identifier and/or the second identifier being one identifier among a group of predetermined identifiers; a haptic module, configured to generate a first initial haptic signal based on the first content and the associated first identifier, and generating a second initial haptic signal based on the second content and the associated second identifier; a machine-learning module, configured to process, by a machine-learning module, the first content to generate a first analysis on the first content, and processing the second content to generate a second analysis on the second content; a haptic driver, configured to modulate the first initial haptic signal according to the first analysis to output a first haptic control signal, and modulating the second initial haptic signal according to the second analysis to output a second haptic control signal; and an actuator, configured to be driven according to the first haptic control signal and/or the second haptic control signal.

In Example 18, the subject matter of Example 17 may optionally include that the machine-learning module is configured to generate the first analysis so as to comprise information about whether the first content comprises an undesirable content and generate the second analysis so as to comprise information about whether the second content comprises an undesirable content.

In Example 19, the subject matter of Example 18 may optionally include that the machine-learning module is trained by processing a plurality of audio profiles, the plurality of audio profiles comprising a game profile, a voice profile and/or a music profile.

In Example 20, the subject matter of Example 19 may optionally include that a threshold of accuracy for the training is preset.

In Example 21, the subject matter of Example 17 may optionally include that the haptic module is configured to generate a first initial haptic signal and generate a second initial haptic signal comprises generating the first and second initial haptic signals using an audio-to-haptic algorithm.

In Example 22, the subject matter of Example 21 may optionally include that a first audio-to-haptic algorithm is selected in accordance with the first identifier associated with the first media stream and a second audio-to-haptic algorithm is selected in accordance with the second identifier associated with the second media stream.

In Example 23, the subject matter of Example 17 may optionally include that the group of predetermined identifiers comprises identifiers categorized by frequency.

In Example 24, the subject matter of Example 17 may optionally include that if the first content and/or the second content is associated with a predefined identifier among the group of predetermined identifiers, the step of modulating the first initial haptic signal and modulating the second initial haptic signal comprises modulating the first initial haptic signal associated with the predefined identifier with a haptic-reduced indication and/or modulating the second initial haptic signal associated with the predefined identifier with a haptic-reduced indication.

In Example 25, the subject matter of Example 24 may optionally include that the group of predetermined identifiers comprises voice, media streaming or the like, wherein the predefined corresponding identifier is voice.

In Example 26, the subject matter of Example 24 may optionally include that the first analysis comprises a first further identifier and the second analysis comprises a second further identifier, the first or second further identifier being one identifier in a further group of predetermined identifiers.

In Example 27, the subject matter of Example 26 may optionally include that if the first content and/or the second content is not associated with the predefined identifier and if the first analysis comprises the first further identifier being the predefined identifier and/or the second analysis comprises the second further identifier being the predefined identifier, the step of modulating the first initial haptic signal and modulating the second initial haptic signal comprises modulating the first initial haptic signal to output the first haptic control signal with the haptic-reduced indication and/or modulating the second initial haptic signal to output the second haptic control signal with the haptic-reduced indication.

In Example 28, the subject matter of Example 26 may optionally include that if the first analysis does not comprise the first further identifier being the predefined identifier and/or the second analysis does not comprise the second further identifier being the predefined identifier, the step of modulating the first initial haptic signal and modulating the second initial haptic signal comprises modulating the first initial haptic signal to output the first haptic control signal with a haptic pattern and/or modulating the second initial haptic signal to output the second haptic control signal with a haptic pattern.

In Example 29, the subject matter of Example 17 may optionally include that the receiver is configured to: receive the first media stream from the first terminal a first time; receive the second media stream from the second terminal at a second time alternating with the first time.

In Example 30, the subject matter of Example 17 may optionally include that the system is a wireless headset, configured to receive the first media stream and the second media stream occur concurrently.

In Example 31, the subject matter of Example 17 may optionally include a mixer, configured to combine the first and second haptic control signals.

Example 32 is a method including: receiving a plurality of media streams, each of the plurality of media streams from a different one of a plurality of terminals; decoding the plurality of media streams to obtain a plurality of contents in playable formats; associating each of the plurality of media streams with a corresponding identifier, the corresponding identifier selected from a group of predetermined identifiers; generating a plurality of initial haptic signals based on the plurality of contents and the associated corresponding identifiers; processing the plurality of contents to generate a plurality of analysis; modulating the plurality of initial haptic signals according to the plurality of analysis to output a plurality of haptic control signals; and actuating the plurality of haptic control signals.

Example 33 is a computer program comprising instructions to cause the system of claim 17 to execute the steps of the method of Example 1.

Example 34 is a computer-readable medium having stored thereon the computer program of Example 33.

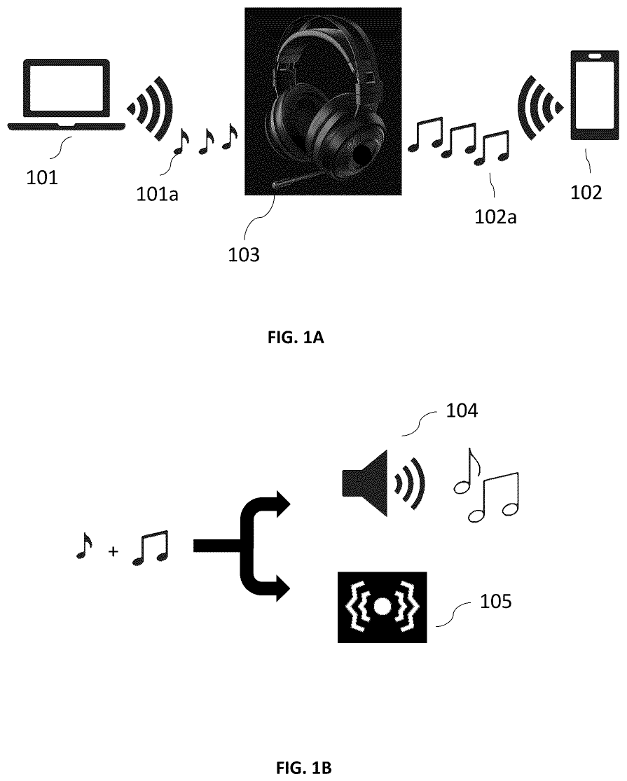

FIG. 1A is a diagram showing an example system 103 according to various embodiments of the present disclosure; FIG. 1B is a diagram showing an example process performed in the example system 103 according to various embodiments of the present disclosure. The example system 103 may include a headphone, an earphone, or other electronic devices capable of delivering haptic effects. Haptic effects may enhance interactions and convey useful information to users through an experience of touch by applying forces, vibrations or motions to the user. The system 103 may receive input from a first device 101 and a second device 102. The system 103 may concurrently receive input from the first device 101 and the second device 102. The first device 101 and the second device 102 may include a laptop, a hand phone, a personal computer or any electronic devices that are capable to send input to the system 103. The input that the first device 101 and/or the second device 102 provide to the system 103 may include audio streams, video streams, media streams (e. g. including both video and audio data), the like or any combination thereof. It should be appreciated that although media streams are described herein as the input, the input may be any suitable input that can be received by/streamed to the system 103 (e. g. a headset), for example, a lighting effect (e. g. Chroma data streaming). Accordingly, the methods (e.g. method 300) and the systems (e. g. system 103) may be adapted to process any suitable input as described above.

In one embodiment, as shown in FIG. 1A, the system 103 may receive a first media stream 101a from the first device 101 and a second media stream 102a from the second device 102. For example, the first media stream 101a from the first device 101 may include game audio and the second media stream 102a from the second device 102 may include music media stream and/or phone call media stream. In another embodiment, the system 103 may receive a media stream from the first device 101 and a video stream from the second device 102. The system 103 may include an interface, e. g. Bluetooth, 2. 4 Ghz wireless, USB, etc., for connecting wirelessly or in wired with the first device 101 and the second device 102 so as to receive the input from the first device 101 and the second device 102.

According to various non-limiting embodiments, the system 103 may process (e.g. decode, manipulate, mix, combine, analyze, etc.) the first input from the first device 101 and the second input from the second device 102 so as to output a first signal including, but not limited to, playable media signal and a second signal actuating haptic effects, as described herein. For example, the system 103 may process (e.g. decode, manipulate, mix, combine, analyze, etc.) the first media stream 101a from the first device 101 and the second media stream 102a from the second device 102 so as to output a playable media signal and a signal actuating haptic effects, as shown in FIG. 1B. In an embodiment, the output playable media signal may include a combination of the processed first media stream 101a from the first device 101 and the processed second media stream 102a from the second device 102. The output signal actuating haptic effects may include a combination of the processed first media stream 101a from the first device 101 and the processed second media stream 102a from the second device 102. The system 103 may be configured to play the combination of the output playable media signal. The system 103 may be also configured to perform the combination of the output signal actuating haptic effects.

In another embodiment, the output playable media signal may include a first individual media signal of the processed first media stream 101a from the first device 101 and a second individual media signal of the processed second media stream 102a from the second device 102. The output signal actuating haptic effects may include a first individual haptic signal of the processed first media stream 101a from the first device 101 and a second individual haptic signal of the processed second media stream 102a from the second device 102. The system 103 may be configured to play the first and/or the second individual media signals. The system 103 may be also configured to perform the first and/or the second individual haptic signals.

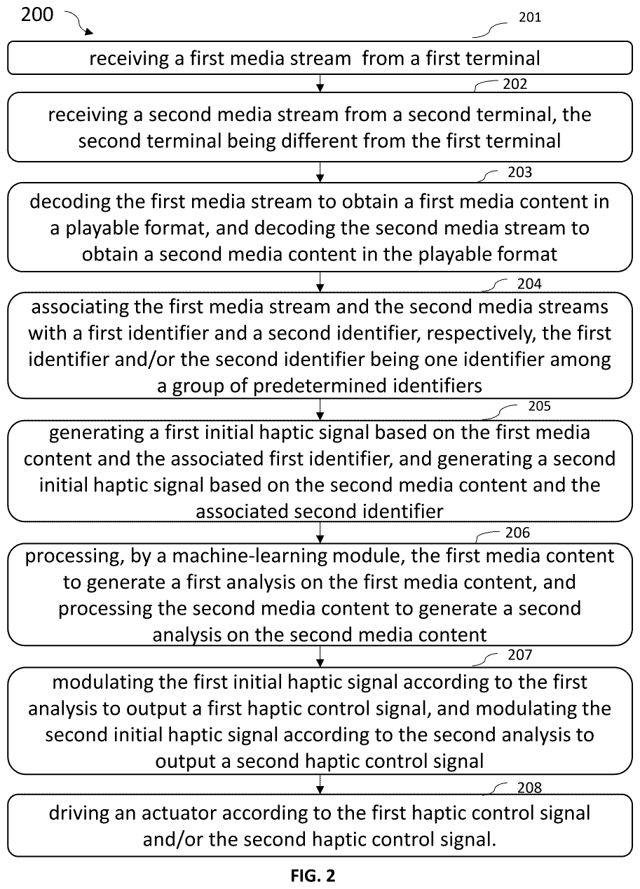

FIG. 2 is a flow chart showing an example method 200 according to an embodiment of the present disclosure. The method 200 may be implemented in the system 103 as well as systems that will be described hereafter (e. g. system 300, 900a, 900b, 1000). According to various non-limiting embodiments, the method 200 may include (step 201, step 202) receiving a first media stream (e.g. the first media stream 101a) from a first terminal (e. g. the first device 101) and receiving a second media stream (e.g. the second media stream 102a) from a second terminal (e. g. the second device 102). In one embodiment, receiving the first media stream may occur concurrently with receiving the second media stream. In another embodiment, receiving the first media stream may occur prior to receiving the second media stream. In other words, receiving the second media stream may occur subsequently after receiving the first media stream, for example, while the first media stream is playing (e. g. in the system 103), that is, the first media stream may have been processed (e. g. decode, manipulate, mix, combine, analyze, etc.). In various embodiments, receiving the first media stream from the first terminal may occur at a first time and receiving the second media stream from the second terminal may occur at a second time alternating with the first time.

The second terminal may be different from the first terminal. This may include that both the first terminal and the second terminal are disposed in one electronic device that is capable to provide two output (e.g. two input to the system 103). This may also include that the first terminal may be separate from the second terminal. The first terminal may be physically located in a different position from where the second terminal is located. The first terminal and/or the second terminal may be located in the cloud.

According to various non-limiting embodiments, the method 200 may include (step 203) decoding the first media stream to obtain a first content in a playable format, and decoding the second media stream to obtain a second content in the playable format. The first and second media streams may be transmitted (e. g. from the first and second device 101, 102 to the system 103) in encrypted data packets, for example, non-playable format. Accordingly, decoding the first and second media streams may include decrypt the first and second media streams, e. g. from the non-playable format to a playable format, optionally using an encryption key pre-stored or generate by an algorithm. In one embodiment, decoding the first media stream may occur concurrently with decoding the second media stream. In another embodiment, decoding the first media stream may occur prior to decoding the second media stream. In other words, decoding the second media stream may occur subsequently after decoding the first media stream, for example, while the first media stream is playing (e. g. in the system 103), that is, the first media stream may have been processed (e. g. decode, manipulate, mix, combine, analyze, etc.).

According to various non-limiting embodiments, the method 200 may include (step 204) associating the first media stream and the second media streams with a first identifier and a second identifier, respectively. This may mean that the first and second media streams may be respectively categorized into a class having an identifier. The first media stream may be categorized into a same class as the second media stream, that is, the first identifier may be the same as the second identifier. The first identifier and/or the second identifier may be one identifier among a group of predetermined identifiers. The group of predetermined identifiers may include voice (e.g. voice call), media streaming (e.g. audio streaming) or the like. The identifiers may be associated to the media streams based on wireless connection setup of the media streams.

According to various non-limiting embodiments, the method 200 may process the media streams to be divided into a plurality of time, frequency, or amplitude based segments. In some embodiments, the group of predetermined identifiers may include identifiers categorized by frequency.

According to various non-limiting embodiments, the method 200 may include (step 205) generating a first initial haptic signal based on the first content and the associated first identifier, and generating a second initial haptic signal based on the second content and the associated second identifier. The first and second initial haptic signals may include instructions for haptic effects. Generating the first initial haptic signal and generating the second initial haptic signal may include generating the first and second initial haptic signals using an audio-to-haptic algorithm. A first audio-to-haptic algorithm may be selected in accordance with the first identifier associated with the first media stream and a second audio-to-haptic algorithm may be selected in accordance with the second identifier associated with the second media stream. The first audio-to-haptic algorithm may be the same as the second audio-to-haptic algorithm in the case where the first identifier is the same as the second identifier. In one example, the audio-to-haptic algorithm may be selected according to frequency. The audio-to-haptic algorithm may be a set of mathematical equations (e.g. algorithms) to convert media signals into haptic patterns. A content identified as game audio may select an audio-to-haptic algorithm that uses wider frequency range to provide full haptic effects, whereas an content with both game audio and speech (e.g. voice) may select an audio-to-haptic algorithm that uses narrower frequency range (below typical human voice) to minimize the unwanted haptic effects coming from human voice.

According to various non-limiting embodiments, the method 200 may include (step 206) processing, by a machine-learning module, the first content to generate a first analysis on the first content, and processing the second content to generate a second analysis on the second content. The machine-learning module may be configured to generate the first analysis so as to comprise information about whether the first content comprises an undesirable content and generate the second analysis so as to comprise information about whether the second content comprises an undesirable content. The undesirable content may include human voice or game narrative that is typically undesirable to actuate haptic effects. The machine-learning module may be trained by processing a plurality of audio profiles, the plurality of audio profiles comprising a game profile, a voice profile and/or a music profile. A threshold of accuracy for the training may be preset. That may mean the training is complete once the accuracy is above the threshold.

According to various non-limiting embodiments, the method 200 may include (step 207) modulating the first initial haptic signal according to the first analysis to output a first haptic control signal, and modulating the second initial haptic signal according to the second analysis to output a second haptic control signal. The first and second haptic control signals may include instructions for actuating haptic effects.

According to various non-limiting embodiments, the method 200 may include (step 208) driving an actuator according to the first haptic control signal and/or the second haptic control signal. The actuator may be configured to move a touch surface that provides vibrotactile haptic effects in response to the first haptic control signal and/or the second haptic control signal. Some haptic effects may utilize an actuator coupled to a housing of the system (e. g. system 103), and some haptic effects may use multiple actuators in sequence and/or in concert. In some embodiments, a touch surface may be simulated by vibrating the surface at different frequencies. In such an embodiment, the actuator may comprise one or more of, for example, a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA).

According to various non-limiting embodiments, the method 200 may process (e.g. step 204) the media streams (e.g. the contents) to be individually analyzed for the presence of certain components (e.g., speech, special effects, background noise, or music). The method 200 may associate the content with an identifier, e.g. categorize each content based on the presence of one or more components. For example, an content including sounds associated with gunfire, explosions, and a car revving may be associated with an identifier “game audio”. Further, the method 200 may generate (e.g. step 205) an initial haptic signal, based on the content associated with the identifier “game audio”, having instructions for a specific haptic effect, or set of haptic effects, e.g., high intensity vibrations synched with the occurrence of components such as the gunfire and explosions.

According to various non-limiting embodiments, the method 200 may process the media streams to isolate (e. g. step 206) one or more components (e.g. undesirable content) in the media stream. For example, the method 200 may analyze the media stream to detect and isolate various sounds. In one embodiment, a media stream may comprise a mixed audio signal (e. g., a signal that includes speech, special effects (e. g., explosions, gunfire, mechanical noises), animal sounds, or musical instruments (e. g., piano, guitar, drums, machines etc.)). In such an embodiment, the method 200 may isolate certain sound in the media stream, e. g., isolating the speech, and the method 200 may associate (e. g. step 206) a further identifier to the remaining component(s). In some embodiments, the method 200 may isolate a plurality of sources, and associate (e. g. step 206) a further identifier to one or more of the plurality of sources of the remaining component(s). For example, in one illustrative embodiment, the method 200 may separate the game narrative from the gunfire. In such an embodiment, the method 200 may associate the gunfire with a further identifier “game audio”. Further, in one embodiment, the method 200 may isolate the components (e. g., the game narrative) and determine to modulate (e. g. step 207) the initial haptic signal with a haptic-reduced indication. For example, in one embodiment, the method 200 may modulate (e. g. step 207) the initial haptic signal with a haptic-reduced indication so as to haptic effects associated with the components. The initial haptic signal with haptic-reduced indication may actuate reduced or suppressed haptic effects.

As will be discussed in further detail below, any number of components may be found in a media stream. Embodiments of the present disclosure provide systems and methods for identifying these components, and then determining and outputting haptic effects that are synchronized with these components. Further, in some embodiments, the systems and methods discussed herein may be used to determine haptic effects associated with other types of signals, e.g., pressure, acceleration, velocity, or temperature signals.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

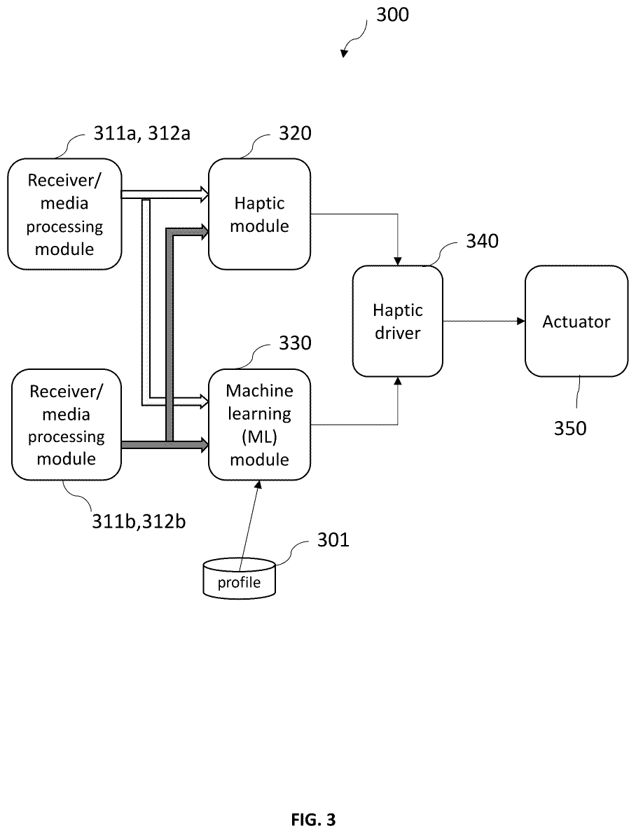

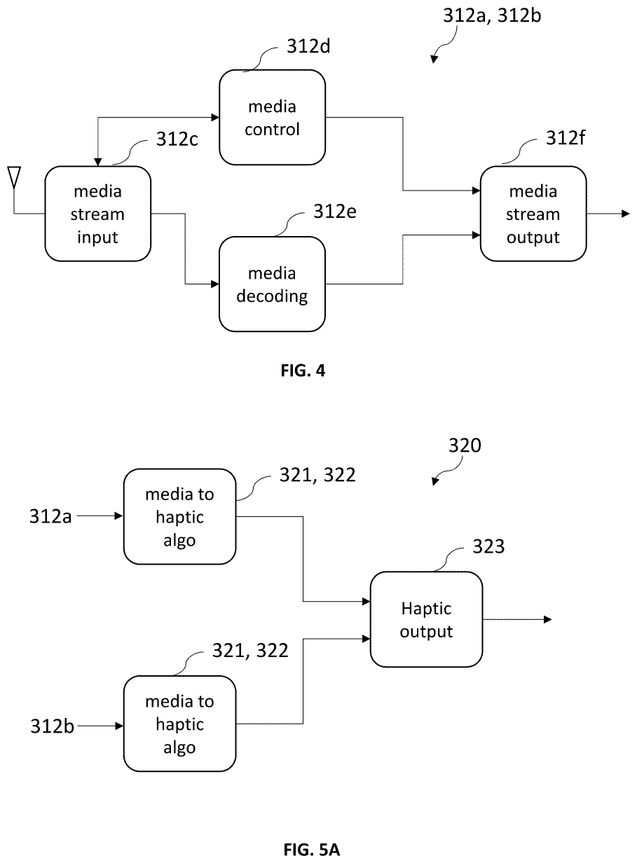

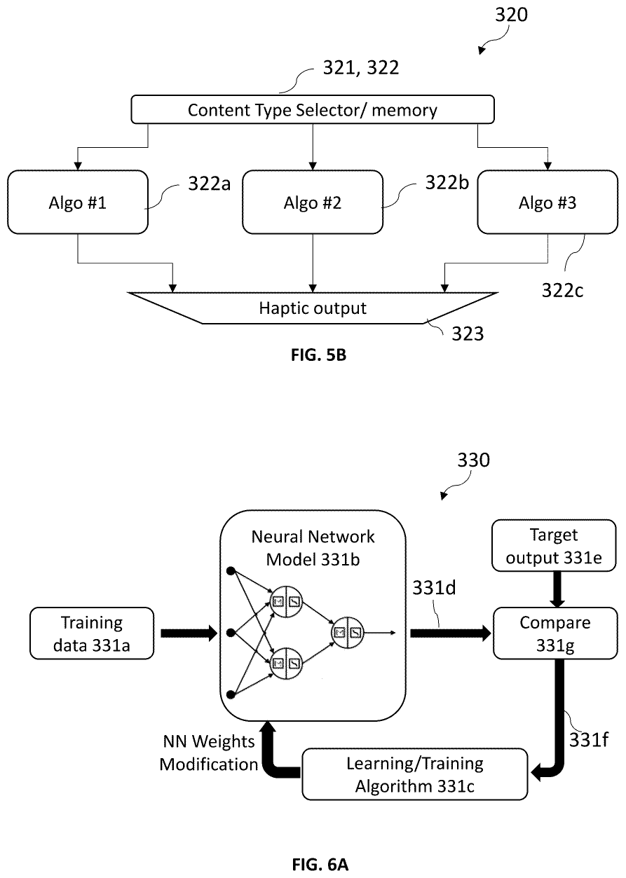

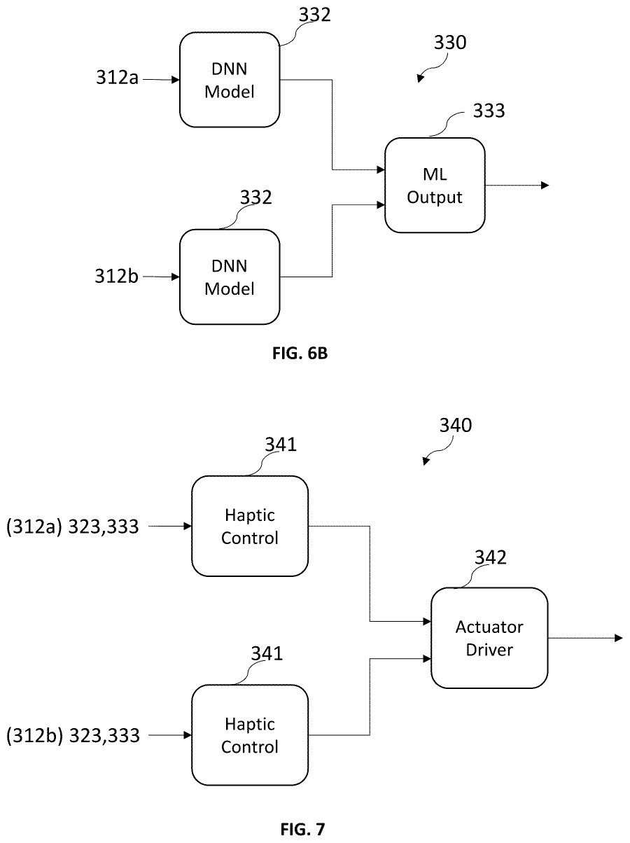

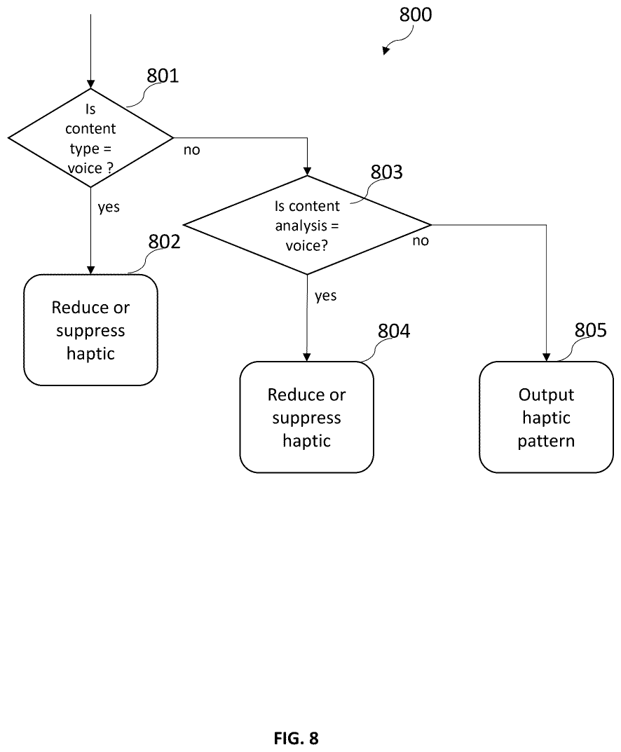

FIG. 3 is a block diagram showing an example system 300 according to an embodiment of the present disclosure. FIG. 4 is a block diagram showing a media processing module 311a, 311b of the example system 300 of FIG. 3. FIGS. 5A and 5B are block diagrams showing a haptic module 320 of the example system 300 of FIG. 3. FIGS. 6A and 6B are diagrams showing a machine-learning module 330 of the example system 300 of FIG. 3. FIG. 7 is a block diagram showing a haptic driver 340 of the example system 300 of FIG. 3. FIG. 8 is a flow chart showing a process performed in the haptic driver 340 of FIG. 7. With reference to FIGS. 3-4, 5A-5B, 6A-6B and 7-8, the system 300 will be described below. The system 300 may be a wireless headset, configured to concurrently receive a first media stream and a second media stream.

According to various non-limiting embodiments, the system 300 may include a receiver 311a, 311b, a media processing module 312a, 312b, a haptic module 320, a Machine Learning (ML) module 330, a haptic driver 340 and an actuator 350. Some components of the system 300, for example, the receiver 311a, 311b, and the media processing module 312a, 312b that are shown collectively in FIG. 3, may be separately as individual components. Some components of the system 300, for example, the haptic module 320 and the ML module 330 that are shown separately in FIG. 3, may be combined as a single component. Furthermore, the system 300 may include further component(s) not shown in FIG. 3.

In various embodiments, the receiver 311a, 311b, may be configured to receive a first media stream (e. g. the first media stream 101a) from a first terminal (the first device 101) and a second media stream (e.g. the second media stream 102a) from a second terminal (the second device 102). That may mean the receiver 311a may be configured to receive the first media stream (e. g. the first media stream 101a) from the first terminal (the first device 101), and the receiver 311b may be configured to receive the second media stream (e. g. the second media stream 102a) from the second terminal (the second device 102). In one embodiment, the receiver 311a may receive the first media stream concurrently with the receiver 311b receiving the second media stream. By “concurrently”, the first terminal and the second terminal may actively transmit media streams to the system 300 at the same time (e. g. a period of time). “Concurrently” may not be used to limit the transmission from the first and second terminal occurring in a same single time slot of radio frequency channel. In another embodiment, the receiver 311a may receive the first media stream prior to the receiver 311b receiving the second media stream. In other words, the receiver 311b may receive the second media stream subsequently after the receiver 311a receives the first media stream, for example, while the first media stream is playing (e. g. in the system 103), that is, the first media stream may have been processed (e. g. decode, manipulate, mix, combine, analyze, etc.). In various embodiments, the receiver 311a may receive the first media stream from the first terminal at a first time and the receiver 311b may receive the second media stream from the second terminal at a second time alternating with the first time.

The second terminal may be different from the first terminal. This may mean that both the first terminal and the second terminal are disposed in one electronic device that is capable to provide two output (e.g. two input to the system 103). This may also mean that the first terminal may be separate from the second terminal. The first terminal may be physically located in a different position from where the second terminal is located. The first terminal and/or the second terminal may be located in the cloud. The receiver 311a, 311b, may receive input (e.g. the first media stream, the second media stream) wirelessly or in wired. The receiver 311a, 311b may include an interface for receiving the input. The interface(s) may include one or more adapters, modems, connectors, sockets, terminals, ports, slots, and the like.

Referring to FIGS. 3 and 4, in various embodiments, the media processing module 312a, 312b may include an media stream input module 312c, a media control module 312d, a media decoding module 312e and an media stream output module 312f. The receiver 311a, 311b may transmit the received first media stream, the received second media stream to the media stream input module 312c of media processing module 312a, 312b. The media processing module 312a, 312b may be configured to decode, by the media decoding module 312e, the first media stream to obtain a first content in a playable format, and decode, by the media decoding module 312e, the second media stream to obtain a second content in the playable format. That may mean the media processing module 312a may be configured to decode the first media stream to obtain a first content in a playable format, and the media processing module 312b may be configured to decode the second media stream to obtain a second content in the playable format.

The media processing module 312a, 312b may be also configured to associate, by the media control module 312d, the first media stream and the second media streams with a first identifier and a second identifier, respectively. That may mean that the media processing module 312a may be configured to associate the first media stream with a first identifier and the media processing module 312b may be configured to associate the second media stream with a second identifier. The first identifier and/or the second identifier may be one identifier among a group of predetermined identifiers. The group of predetermined identifiers may include voice (e.g. voice call), media streaming (e.g. audio streaming) or the like. The identifiers may be associated to the media streams based on wireless connection setup of the media streams. For example, a first identifier (e.g. media streaming) may be assigned to a first terminal device (e.g. device 101) based on a first wireless connection setup (e.g. by Wi-Fi) between the first terminal device and the system 300; a second identifier (e.g. voice) may be assigned to a second terminal device (e.g. device 102) based on a second wireless connection setup (e.g. by Bluetooth) between the second terminal device and the system 300. The group of predetermined identifiers may include identifiers categorized by frequency.

The media processing module 312a, 312b may be further configured to transmit the first content and the associated first identifier, output of the media stream output module 312f of the media processing module 312a, and the second content and the associated second identifier, output of the media stream output module 312f of the media processing module 312b, to the haptic module 320. The media processing module 312a, 312b may be configured to transmit the first content and the second content to the ML module 330. Further, the media processing module 312a, 312b may be configured to transmit the associated first identifier and the associated second identifier to the ML module 330.

Now referring to FIGS. 3 and 5A-5B, in various embodiments, the haptic module 320 may include a memory 321 having audio to haptic algorithms stored thereon, a content type selector 322 and a haptic output module 323. The haptic module 320 may receive the first content and the associated first identifier, and the second content and the associated second identifier from the media processing module 312a, 312b. The haptic module 320 may be configured to generate a first initial haptic signal based on the first content and the associated first identifier, and generating a second initial haptic signal based on the second content and the associated second identifier. The first and second initial haptic signals may include instructions for haptic effects. Generating the first initial haptic signal and generating the second initial haptic signal may include generating the first and second initial haptic signals using an audio-to-haptic algorithm. A first audio-to-haptic algorithm (e.g. 322a or 322b or 322c) may be selected by the content type selector 322 in accordance with the first identifier associated with the first media stream and a second audio-to-haptic algorithm (e.g. 322a or 322b or 322c) may be selected by the content type selector 322 in accordance with the second identifier associated with the second media stream. The first audio-to-haptic algorithm may be the same as the second audio-to-haptic algorithm in the case where the first identifier is the same as the second identifier. The first and second initial haptic signals may be output to the haptic driver 340 by the haptic output module 323.

Now referring to FIGS. 3 and 6A-6B, in various embodiments, the first content and the second content may be transmitted to the ML module 330 by the media processing module 312a, 312b. The ML module 330 may be trained by processing a plurality of audio profiles (e.g. 301) as training data 331a. The plurality of audio profiles may include a game profile, a voice profile and/or a music profile. The training data 331a may be processed using a learning/training algorithm 331c with weights modification in a neural network (NN) model 331b. The prediction 331d of the processed training data may be compared 331g with target output 331e. The error signal 331f may be feedback to the learning/training algorithm 331c and weights may be modified accordingly. A threshold of accuracy (e.g. the discrepancy between the prediction 331d of the processed training data and the target output 331e for the training data may be preset. That may mean the training is complete once the accuracy is above the threshold.

The ML module 330 may be configured to process (e. g. using deep neural network (DNN) model 332) the first content to generate a first analysis on the first content, and process (e. g. using deep neural network (DNN) model 332) the second content to generate a second analysis on the second content. The ML module 330 may be configured to generate the first analysis so as to comprise information about whether the first content comprises an undesirable content and generate the second analysis so as to comprise information about whether the second content comprises an undesirable content. The undesirable content may include human voice or game narrative that is typically undesirable to actuate haptic effects. The first analysis may include a first further identifier and the second analysis may include a second further identifier. The first or second further identifier may be one identifier in a further group of predetermined identifiers.

In various embodiments, the group of predetermined identifiers may be considered a first level of identifiers and the further group of predetermined identifiers may be considered a second level of identifiers. That may mean the second level of identifiers in the further group of predetermined identifiers are further (e.g. refined, fine-tuned, subdivided, elaborated) identifiers of the first level of identifiers in the group of predetermined identifiers. The further (e.g. refined, fine-tuned, subdivided, elaborated) identifiers may include phone call, voice call, team call, music, game narrative, game audio or the like. The further group of predetermined identifiers may include the identifiers in the group of predetermined identifiers with (e.g. tagged or attached or labelled with) a further (e.g. refined, fine-tuned, subdivided, elaborated) identifier, for example, voice with a further (e.g. refined, fine-tuned, subdivided, elaborated) identifier game narrative, media streaming with a further (e.g. refined, fine-tuned, subdivided, elaborated) identifier game audio or the like.

The ML module 330 may further analyze the contents to classify (e. g. refine, fine-tune, subdivide, elaborate) the first level of identifiers (e. g. voice or media streaming) with the second level of identifiers (e. g. voice with a further identifier game narrative or media streaming with a further identifier game audio). The ML module 330 may be provided to further classify (e. g. refine, fine-tune, subdivide, elaborate) the audio contents so as to identify content with which haptic effects are undesirable.

In various embodiments, the further group of predetermined identifiers may include further (e. g. refined, fine-tuned, subdivided, elaborated) identifiers, for example, phone call, voice call, team call, music, game narrative, game audio or the like. The ML module 330 may further analyze the contents to replace/substitute/supersede the identifiers of the group of predetermined identifiers (e. g. voice or media streaming) with the further identifiers of the further group of predetermined identifiers (e. g. voice with a further identifier voice call, or media streaming with a further identifier game audio). The ML module 330 may be provided to further classify (e. g. replace, substitute, supersede) the audio contents so as to identify content with which haptic effects are undesirable.

The first and second analysis on the first and second contents may be output to the haptic driver 340 by an ML output module 333.

Now referring to FIGS. 3 and 7, in various embodiments, the haptic driver 340 may include a haptic control module 341 and an actuator driver 342. The haptic driver 340 may be configured to receive the first and second analysis on the first and second contents from the ML module 330 and receive the first and second contents and the associated first and second identifiers from the haptic module 320. The haptic driver 340 may be configured to modulate, by the haptic control 341, the first initial haptic signal according to the first analysis to output a first haptic control signal, and modulating, by the haptic control 341, the second initial haptic signal according to the second analysis to output a second haptic control signal. The actuator driver 342 may be configured to output the first and second control signals to the actuator 350. The first and second haptic control signals may include instructions for actuating haptic effects.

FIG. 8 depicts a process 800 that the haptic driver 340 performs, in particular, by the haptic control module 341. According to various non-limiting embodiments, the haptic driver 340 may determine if the first content and/or the second content is associated with a predefined identifier among the group of predetermined identifiers 801. The predefined corresponding identifier may include one or more identifiers, for example, voice. If yes, the haptic driver 340 may be configured to modulate the first initial haptic signal associated with the predefined identifier with a haptic-reduced indication and/or modulate the second initial haptic signal associated with the predefined identifier with a haptic-reduced indication 802. If no, the haptic driver 340 may be configured to determine if the first analysis comprises the first further identifier being the predefined identifier and/or the second analysis comprises the second further identifier being the predefined identifier 803. If yes, the haptic driver 340 may be configured to modulate the first initial haptic signal to output the first haptic control signal with the haptic-reduced indication and/or modulating the second initial haptic signal to output the second haptic control signal with the haptic-reduced indication 804. If no, the haptic driver 340 may be configured to modulate the first initial haptic signal to output the first haptic control signal with a haptic pattern and/or modulating the second initial haptic signal to output the second haptic control signal with a haptic pattern 805.

In various embodiments, if the identifiers of the group of predetermined identifiers (e.g. voice or media streaming) are replaced/substituted/superseded with the further identifiers of the further group of predetermined identifiers, at step 803, the haptic driver 340 may be configured to determine if the first analysis comprises the first further identifier being a further predefined identifier of the further group of predetermined identifiers and/or the second analysis comprises the second further identifier being the further predefined identifier. The further predefined identifier may include one or more identifiers such as voice call, game narrative.

In various embodiments, the actuator 350 may be configured to be driven according to the first haptic control signal and/or the second haptic control signal. The actuator 350 may be configured to move a touch surface that provides vibrotactile haptic effects in response to the first haptic control signal and/or the second haptic control signal. Some haptic effects may utilize an actuator coupled to a housing of the system (e. g. system 103), and some haptic effects may use multiple actuators in sequence and/or in concert. In some embodiments, a touch surface may be simulated by vibrating the surface at different frequencies. In such an embodiment, the actuator 350 may comprise one or more of, for example, a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA).

According to various non-limiting embodiments, the system 300 may further include a mixer (not shown), configured to combine the first and second haptic control signals. Accordingly, the actuator 350 may be configured to be driven according to the combined haptic signal.

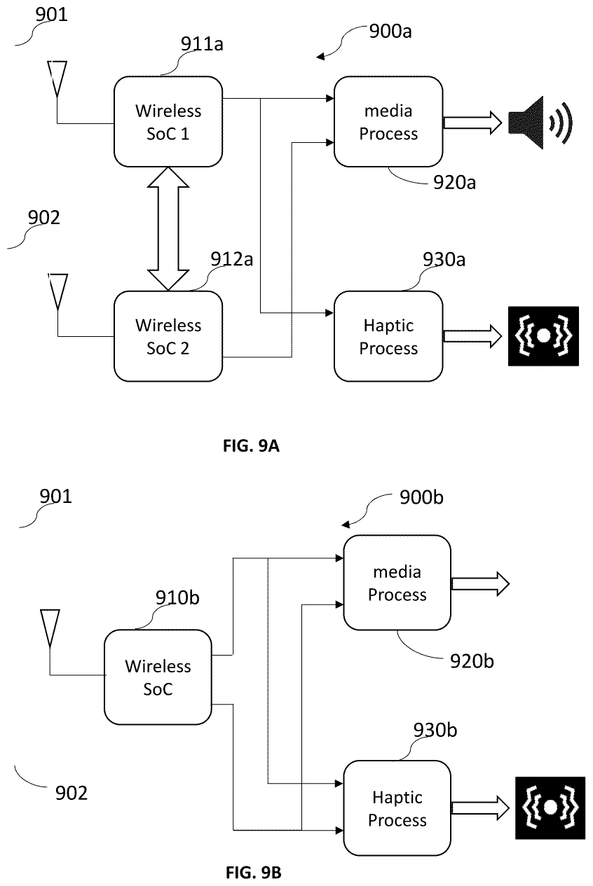

FIGS. 9A and 9B is a diagram showing example systems 900a, 900b according to various embodiments of the present disclosure. The system 900a, 900b may include at least one processor and at least one memory including computer program code for one or more programs, the at least one memory and the computer program code configured to, with the at least one processor, cause the system at least to: receive a first media stream from a first terminal (e.g. the first device 901); receive a second media stream from a second terminal (e.g. the second device 902), the second terminal being different from the first terminal; decode the first media stream to obtain a first content in a playable format, and decoding the second media stream to obtain a second content in the playable format; associate the first media stream and the second media streams with a first identifier and a second identifier, respectively, the first identifier and/or the second identifier being one identifier among a group of predetermined identifiers; generate a first initial haptic signal based on the first content and the associated first identifier, and generating a second initial haptic signal based on the second content and the associated second identifier; process, by a machine-learning module, the first content to generate a first analysis on the first content, and processing the second content to generate a second analysis on the second content; modulate the first initial haptic signal according to the first analysis to output a first haptic control signal, and modulating the second initial haptic signal according to the second analysis to output a second haptic control signal; and drive an actuator according to the first haptic control signal and/or the second haptic control signal.

The system 900a, 900b may receive input from a first device 901 (e.g. a personal computer) and a second device 902 (e.g. a hand phone). The system 900a, 900b may concurrently receive input from the first device 901 and the second device 902. The system 900a may include a first and a second wireless System-on-Chips (SoCs) 911a, 912a. The first SoC 911a may be configured to receive input from the first device 901 and the second SoC 912a may be configured to receive input from the second device 902. There may be a receiver (e.g. the receiver 311a/311b), a media processing module (e.g. the media processing module 312a/312b), a haptic module (e.g. the haptic module 320), a ML module (the ML module 330), a haptic driver (the haptic driver 340) and an actuator (e.g. the actuator 350) arranged in each of the first and second SoCs 911a, 912a.

The system 900b may include a wireless SoC 910b. The SoC 910b may be configured to receive input from both the first device 901 and the second device 902. There may be two receivers (e.g. the receivers 311a, 311b), two media processing modules (e.g. the media processing modules 312a, 312b), a haptic module (e.g. the haptic module 320), a ML module (the ML module 330), a haptic driver (the haptic driver 340) and an actuator (e.g. the actuator 350) arranged in the SoC 910b.

The system 900a, 900b may process (e.g. decode, manipulate, mix, combine, analyze, etc.) the input from the first device 901 and the second device 902, and output playable contents through the media process 920a, 920b and the haptic control signals (e.g. haptic effects) through the haptic process 930a, 930b.

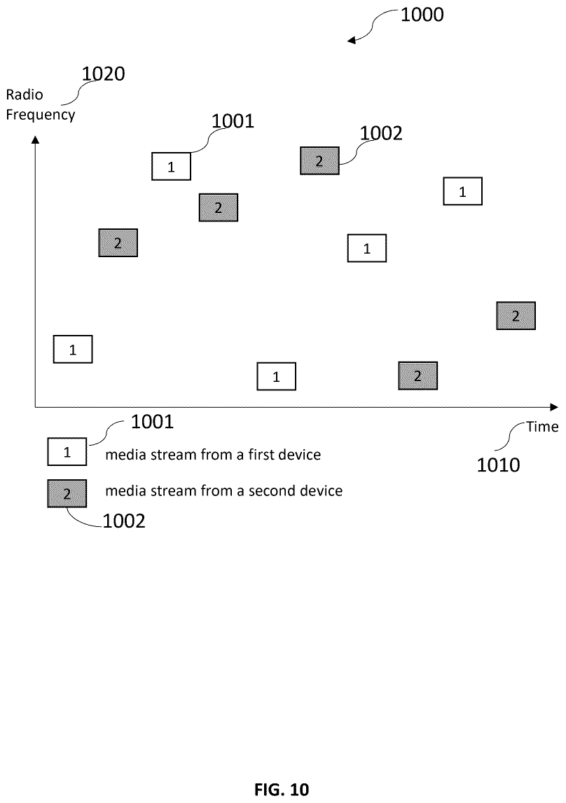

FIG. 10 is a diagram 1000 showing media stream transmission occurred in an example system according to an embodiment of the present disclosure. The example system may include a multiplexer that is capable of receiving multiple input, selecting among the multiple input and forwarding the selected input to an output. The x-axis 1010 of the diagram 1000 represents time and the y-axis 1020 of the diagram 1000 represents radio frequency. The example system may receive a first media stream from a first device, denoted as 1001 and a second media stream from a second device, denoted as 1002.

According to various non-limiting embodiments, the system may receive the first media stream from the first device at a first time and receive the second media stream from the second device at a second time alternating with the first time. Stated differently, the system may alternatively receive the first media stream from the first device and the second media stream from the second device in a periodic manner. That may mean the system receives one media stream at any one time through a radio frequency channel. That may also mean the system receives the first media stream at the first time through a first radio frequency channel and the second media stream at the second through the first radio frequency channel or a second radio frequency channel.

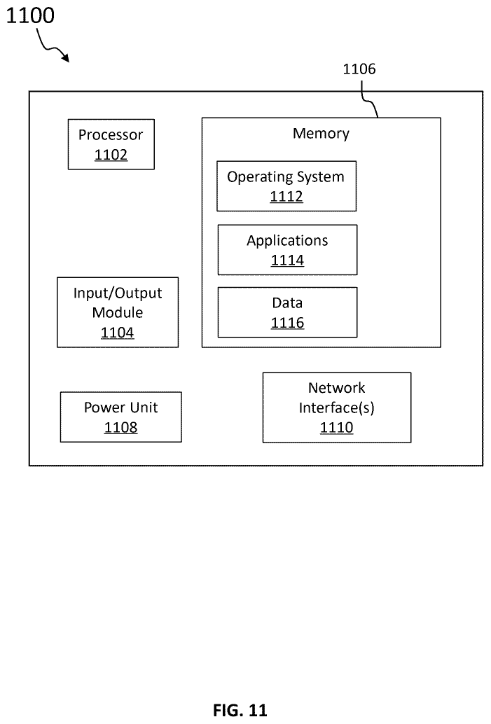

FIG. 11 is a block diagram showing an example electronic device 1100, according to an embodiment of the present disclosure. The electronic device 1100 may be a laptop computer, a desktop computer, a tablet computer, an automobile computer, a gaming device, a smart phone, a personal digital assistant, a server, or other electronic devices capable of running computer applications. In some embodiments, the electronic device 1100 includes a processor 1102, an input/output (I/O) module 1104, memory 1106, a power unit 1108, and one or more network interfaces 1110. The electronic device 1100 can include additional components. In some embodiments, the processor 1102, input/output (I/O) module 1104, memory 1106, power unit 1108, and the network interface(s) 1110 are housed together in a common housing or other assembly.

The example processor 1102 can execute instructions, for example, to generate output data based on data inputs. The instructions can include programs, codes, scripts, modules, or other types of data stored in memory (e. g., memory 1106). Additionally or alternatively, the instructions can be encoded as pre-programmed or re-programmable logic circuits, logic gates, or other types of hardware or firmware components or modules. The processor 1102 may be, or may include, a multicore processor having a plurality of cores, and each such core may have an independent power domain and can be configured to enter and exit different operating or performance states based on workload. Additionally or alternatively, the processor 1102 may be, or may include, a general-purpose microprocessor, as a specialized co-processor or another type of data processing apparatus. In some cases, the processor 1102 performs high-level operation of the electronic device 1100. For example, the processor 1102 may be configured to execute or interpret software, scripts, programs, functions, executables, or other instructions stored in the memory 1106.

The example I/O module 1104 may include a mouse, keypad, touch screen, scanner, optical reader, and/or stylus (or other input device(s)) through which a user of the electronic device 1100 may provide input to the electronic device 1100, and may also include one or more of a speaker for providing audio output and a video display device for providing textual, audiovisual, and/or graphical output.

The example memory 1106 may include computer-readable storage media, for example, a volatile memory device, a non-volatile memory device, or both. The memory 1106 may include one or more read-only memory devices, random-access memory devices, buffer memory devices, or a combination of these and other types of memory devices. In some instances, one or more components of the memory can be integrated or otherwise associated with another component of the electronic device 1100. The memory 1106 may store instructions that are executable by the processor 1102. In some examples, the memory 1106 may store instructions for an operating system 1112 and for application programs 1114. The memory 1106 may also store a database 1116.

The example power unit 1108 provides power to the other components of the electronic device 1100. For example, the other components may operate based on electrical power provided by the power unit 1108 through a voltage bus or other connection. In some embodiments, the power unit 1108 includes a battery or a battery system, for example, a rechargeable battery. In some embodiments, the power unit 1108 includes an adapter (e.g., an AC adapter) that receives an external power signal (from an external source) and coverts the external power signal to an internal power signal conditioned for a component of the electronic device 1100. The power unit 1108 may include other components or operate in another manner.

The electronic device 1100 may be configured to operate in a wireless, wired, or cloud network environment (or a combination thereof). In some embodiments, the electronic device 1100 can access the network using the network interface(s) 1110. The network interface (s) 1110 can include one or more adapters, modems, connectors, sockets, terminals, ports, slots, and the like. The wireless network that the electronic device 1100 accesses may operate, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e. g., Wi-Fi networks), and others. Examples of PANs include networks that operate according to short-range communication standards (e. g., BLUETOOTH®, Near Field Communication (NFC), ZigBee), millimeter wave communications, and others. The wired network that the electronic device 1100 accesses may, for example, include Ethernet, SONET, circuit-switched networks (e. g., using components such as SS7, cable, and the like), and others.

Various aspects of what is described here have provided a method or system that provides improved haptic effect, thereby augmenting user experience.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e. g., multiple CDs, disks, or other storage devices).

Some of the operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e. g., an FPGA (field programmable gate array) or an ASIC (application specific integrated circuit). The apparatus can also include, in addition to hardware, code that creates an execution environment for the computer program in question, e. g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e. g., one or more scripts stored in a markup language document), in a single file dedicated to the program, or in multiple coordinated files (e. g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e. g., an FPGA (field programmable gate array) or an ASIC (application specific integrated circuit).

While this specification contains many details, these should not be understood as limitations on the scope of what may be claimed, but rather as descriptions of features specific to particular examples. Certain features that are described in this specification or shown in the drawings in the context of separate embodiments can also be combined. Conversely, various features that are described or shown in the context of a single embodiment can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method comprising:
receiving a first media stream from a first terminal;
receiving a second media stream from a second terminal, the second terminal being different from the first terminal;
decoding the first media stream to obtain a first content in a playable format, and decoding the second media stream to obtain a second content in the playable format;
associating the first media stream and the second media stream with a first identifier and a second identifier, respectively, the first identifier and/or the second identifier being one identifier among a group of predetermined identifiers;
generating a first initial haptic signal based on the first content and the associated first identifier, and generating a second initial haptic signal based on the second content and the associated second identifier;
processing the first content to generate a first analysis on the first content, and processing the second content to generate a second analysis on the second content;
modulating the first initial haptic signal according to the first analysis to output a first haptic control signal, and modulating the second initial haptic signal according to the second analysis to output a second haptic control signal; and
driving an actuator according to the first haptic control signal and/or the second haptic control signal.

2. The method of claim 1, wherein processing the first content and the second content is by a machine-learning module configured to generate the first analysis so as to comprise information about whether the first content comprises an undesirable content and generate the second analysis so as to comprise information about whether the second content comprises an undesirable content.

3. The method of claim 2, wherein the machine-learning module is trained by processing a plurality of audio profiles, the plurality of audio profiles comprising a game profile, a voice profile and/or a music profile.

4. The method of claim 3, wherein a threshold of accuracy for the training is preset.

5. The method of claim 1, wherein the step of generating a first initial haptic signal and generating a second initial haptic signal comprises generating the first and second initial haptic signals using an audio-to-haptic algorithm.

6. The method of claim 5, wherein a first audio-to-haptic algorithm is selected in accordance with the first identifier associated with the first media stream and a second audio-to-haptic algorithm is selected in accordance with the second identifier associated with the second media stream.

7. The method of claim 1, wherein the group of predetermined identifiers comprises identifiers categorized by frequency.

8. The method of claim 1,
wherein if the first content and/or the second content is associated with a predefined identifier among the group of predetermined identifiers, the step of modulating the first initial haptic signal and modulating the second initial haptic signal comprises modulating the first initial haptic signal associated with the predefined identifier with a haptic-reduced indication and/or modulating the second initial haptic signal associated with the predefined identifier with a haptic-reduced indication.

9. The method of claim 8, wherein the group of predetermined identifiers comprises voice, media streaming or the like, wherein the predefined identifier is voice.

10. The method of claim 8, wherein the first analysis comprises a first further identifier and the second analysis comprises a second further identifier, the first further identifier and/or the second further identifier being one identifier among a further group of predetermined identifiers.

11. The method of claim 10, wherein if the first content and/or the second content is not associated with the predefined identifier and if the first analysis comprises the first further identifier being the predefined identifier and/or the second analysis comprises the second further identifier being the predefined identifier, the step of modulating the first initial haptic signal and modulating the second initial haptic signal comprises modulating the first initial haptic signal to output the first haptic control signal with the haptic-reduced indication and/or modulating the second initial haptic signal to output the second haptic control signal with the haptic-reduced indication.

12. The method of claim 10, wherein if the first analysis does not comprise the first further identifier being the predefined identifier and/or the second analysis does not comprise the second further identifier being the predefined identifier, the step of modulating the first initial haptic signal and modulating the second initial haptic signal comprises modulating the first initial haptic signal to output the first haptic control signal with a haptic pattern and/or modulating the second initial haptic signal to output the second haptic control signal with a haptic pattern.

13. The method of claim 1, wherein the first media stream and the second media stream occur concurrently.

14. The method of claim 13, further comprising:
receiving the first media stream from the first terminal at a first time;
receiving the second media stream from the second terminal at a second time alternating with the first time.

15. The method of claim 1, prior to the step of driving an actuator, further comprising:
combining the first and second haptic control signals; and
driving the actuator according to the combined haptic signal.

16. (canceled)

17. A system comprising:
a receiver, configured to receive a first media stream from a first terminal and a second media stream from a second terminal, the second terminal being different from the first terminal;
a media processing module, configured to decode the first media stream to obtain a first content in a playable format, and decoding the second media stream to obtain a second content in the playable format, and configured to associate the first media stream and the second media streams with a first identifier and a second identifier, respectively, the first identifier and/or the second identifier being one identifier among a group of predetermined identifiers;
a haptic module, configured to generate a first initial haptic signal based on the first content and the associated first identifier, and generating a second initial haptic signal based on the second content and the associated second identifier;
a machine-learning module, configured to process, by a machine-learning module, the first content to generate a first analysis on the first content, and processing the second content to generate a second analysis on the second content;
a haptic driver, configured to modulate the first initial haptic signal according to the first analysis to output a first haptic control signal, and modulating the second initial haptic signal according to the second analysis to output a second haptic control signal; and
an actuator, configured to be driven according to the first haptic control signal and/or the second haptic control signal.

18. (canceled)

19. (canceled)

20. (canceled)

21. (canceled)

22. (canceled)

23. The system of claim 17, wherein the group of predetermined identifiers comprises identifiers categorized by frequency.

24. (canceled)

25. (canceled)

26. (canceled)

27. (canceled)

28. (canceled)

29. (canceled)

30. The system of claim 17, wherein the system is a wireless headset, configured to receive the first media stream and the second media stream occur concurrently.

31. The system of claim 17, further comprising:
a mixer, configured to combine the first and second haptic control signals.

32. A method comprising:
receiving a plurality of media streams, each of the plurality of media streams from a different one of a plurality of terminals;
decoding the plurality of media streams to obtain a plurality of contents in playable formats;
associating each of the plurality of media streams with a corresponding identifier, the corresponding identifier selected from a group of predetermined identifiers;
generating a plurality of initial haptic signals based on the plurality of contents and the associated corresponding identifiers;
processing the plurality of contents to generate a plurality of analysis;
modulating the plurality of initial haptic signals according to the plurality of analysis to output a plurality of haptic control signals; and
actuating the plurality of haptic control signals.

33. (canceled)

34. (canceled)
